(19) United States
(12) Patent Application Publication
(10) Pub. No.: US 2021/0312808 A1
(43) Pub. Date: Oct. 7, 2021

(54) CAR NUMBER-BASED PARKING ELEVATOR CONTROL

(71) Applicants: Hwa Jin LEE, Gangnam-gu, Seoul (KR); PARKINGCLOUD CO., LTD., Yeongdeungpo-gu, Seoul (KR)

(72) Inventors: Hwa Jin LEE, Gangnam-gu, Seoul (KR); Sang Yong SHIN, Gangseo-gu, Seoul (KR)

(21) Appl. No.: 17/267,842

(22) PCT Filed: Jun. 25, 2019
(86) PCT No.: PCT/KR2019/007649

§ 371 Date: Feb. 11, 2021

(30) Foreign Application Priority Data
Aug. 14, 2018 (KR) 10-2018-0095145

(51) Int. Cl. G08G 1/14; E04H 6/18; G06Q 30/04; B60L 53/66; G06K 9/00; G06F 16/24

(52) U.S. Cl. CPC G08G 1/141; G08G 1/145; E04H 6/18; G06K 2209/15; B60L 53/665; G06K 9/00664; G06F 16/24; G06Q 30/04

(57) ABSTRACT

The present disclosure relates to a parking elevator system that provides available pallet information by using vehicle information and a method to provide pallet information using the system. The parking elevator system may search a vehicle information database and/or a pallet information database. The vehicle information may be provided directly by a parking user or may be searched from the vehicle information database based on a vehicle number. The vehicle number may be recognized by an LPR device or can be provided directly by the parking user. The vehicle information may include the dimensions of a vehicle, whether the vehicle is an electric vehicle and the like, and the pallet information may include the dimensions of a vehicle that can be parked, a vehicle model, whether an electric vehicle charging facility is provided, parking fee and the like.

### TECHNICAL FIELD

The present disclosure relates to a parking elevator control based on vehicle number and more particularly to, a system and method to control a parking elevator by using information about a vehicle obtained by automatically recognizing a vehicle number.

### BACKGROUND

Unless otherwise indicated herein, the materials described in this section are not prior art to the claims in this application and are not admitted as prior art by inclusion in this section.

In downtown areas of cities, parking elevator systems are being widely used to alleviate the shortage of parking spaces. Such a system is usually designed as a tower, so that a plurality of vehicles can be parked in a vertical direction to increase the space efficiency, and the system needs to ensure that a vehicle can be lifted up and down safely and quickly in the vertical direction. In conventional parking lots, each vehicle occupies a relatively large space. It is advantageous to increase the parking density in order to allow more vehicles to be parked in a parking lot of a predetermined size and increase the space efficiency. Therefore, an elevator system needs to increase the parking density by having various optimal pallets for vehicle sizes. In such a system, when a vehicle is about to park, it is necessary to find a pallet of an appropriate size.

Patent WO2006/039830 is known for an automatic elevator system that finds an optimal pallet for the size of a vehicle and pushes the vehicle. Here, the vehicle is pushed to a parking floor arranged radially around a central elevator. The elevator proposed in this document is for a single vehicle. The entire elevator structure rotates around a vertical axis, so that vehicles can be pushed to different parking floors. A vehicle to be parked is first measured, for example, by means of a scanner to detect a parking space of a parking lot where a relevant robot can locate the vehicle in the most optimal space. The outline of a plan view of the vehicle and the maximum height of the vehicle, i.e., a shadow of the vehicle when light vertically falls down toward the bottom, are used for this measurement.

Meanwhile, the use of electric vehicles has been increasing recently. An electric vehicle is driven by electric energy charged in a battery instead of an internal combustion engine such as a gasoline engine or a diesel engine. The electric vehicle needs to be charged when the battery is consumed, and recently, electric vehicle charging facilities have been being increased. An owner of an electric vehicle may have a charging facility at home to charge the electric vehicle, and outside the home, the owner of the electric vehicle may find a charging station, charge the electric vehicle and pay a fee for charging.

### SUMMARY

In order to find a suitable pallet for a vehicle, a resident staff of a parking elevator may see a vehicle to be parked with the naked eye and call an optimal pallet. However, an arrangement of workers requires cost, training, and management, which is not desirable for implanting an automated system.

The above-described patent WO2006/039830 implements a system for automatically measuring the size of a vehicle, but the system physically measures the size of a vehicle every time and thus requires high costs for introduction and management, which is not desirable.

Meanwhile, it is necessary to introduce a parking elevator system for electric vehicles. That is, it will be better to provide pallets equipped with charging facilities for electric vehicles. When an electric vehicle is about to park, a pallet equipped with a charging facility needs to be provided.

If an electric car can be charged at a parking elevator, a parking fee and a charging fee are charged to a vehicle that uses a charging service while being parked. However, paying the charging fee separately from the parking fee causes inconvenience to the parking user. Accordingly, there is a need for a billing system that enables easy payment for the charging fee. As for an electric vehicle, a system that provides pallets equipped with electric vehicle charging facilities and enables settlement of a parking fee and a charging fee at once is desirable.

If a driver finds out that there is no suitable pallet for the vehicle or there is no available space when arriving at a parking elevator system, it causes inconvenience to the driver because the driver needs to find another nearby parking elevator system. Accordingly, there is a need to provide a system that enables the driver to know in advance whether a target parking elevator system provides a suitable pallet for the vehicle and whether there is an available pallet before arriving at the target parking elevator system.

In addition, when the vehicle waits to enter or exit, advertisements may be provided through a display, a touch screen or a digital signage provided by the system. It is advantageous to provide advertisements that are more suitable and appealing to the driver in the vehicle.

The present disclosure is to solve the above problems and provides a system and method to control a parking elevator by using information about a vehicle obtained by automatically recognizing a vehicle number.

In some embodiments of the present disclosure, a method to control a parking elevator is described. As an example, a method to provide pallet information of a parking elevator based on a vehicle number includes: recognizing, by a vehicle number recognition unit, a vehicle number of a vehicle that enters the parking elevator; acquiring, by a server, vehicle information by accessing a vehicle information database based on the recognized vehicle number; determining, by the server, a pallet based on the vehicle information; and providing pallet information of the determined pallet to a driver of the vehicle.

In another embodiment, a method to provide pallet information of a parking elevator system that is performed by a central server or a local server. This method includes: allowing access to the system in response to a request from a user's device; receiving information about a vehicle through the device; and providing pallet information corresponding to the information about the vehicle to the device.

In yet another embodiment, a method to provide pallet information of a plurality of parking elevator systems that is performed by a central server configured to communicate with a user's device and a plurality of local servers is described. This method includes: allowing access requested through the device; receiving information about a destination location and a vehicle through the device; transmitting the information about the destination location and the vehicle to the plurality of local servers; receiving available parking pallet information corresponding to the information about the vehicle from the local servers; and providing parking elevator information including the available parking pallet information to the device.

Preferably, the information about the vehicle includes the dimensions of the vehicle.

Preferably, when the information about the vehicle is a vehicle number, the above-described method further includes: acquiring, by the central server or local server that has received a vehicle number, additional information about the vehicle by accessing a vehicle information database based on the vehicle number, and the additional information includes at least one of the dimensions of the vehicle and whether the vehicle is an electric vehicle.

Preferably, the information about the vehicle includes whether the vehicle is an electric vehicle, and the pallet information includes whether an electric vehicle charging facility is provided.

Preferably, the pallet information includes a plurality of pallet information from one or more parking elevators, and each pallet information indicates the location of a parking elevator corresponding to each pallet.

In some embodiments of the present disclosure, a parking elevator system for providing pallet information is described. As an example, a parking elevator system equipped with a plurality of pallets includes: a parking number recognition unit that recognizes a vehicle number; a vehicle information database that stores vehicle information corresponding to the vehicle number; a pallet information database that stores pallet information for each pallet, including the dimensions of a vehicle that can be parked on the pallet and whether a charging facility is provided; and a controller that receives the recognized vehicle number, acquires vehicle information corresponding to the recognized vehicle number from the vehicle information database, and searches for pallet information corresponding to the vehicle information.

In some embodiments of the present disclosure, a server of a parking elevator system for providing pallet information is described. As an example, a server provides pallet information of a parking elevator system and includes: a communication unit that communicates with a user's device and a local server of the parking elevator system; and a controller that receives information about a vehicle from the device through the communication unit and provides pallet information corresponding to the vehicle information to the device. Preferably, when the information about the vehicle is a vehicle number, the server that has received the vehicle number accesses a vehicle information database based on the vehicle number to acquire additional information about the vehicle, and the additional information includes at least one of the dimensions of the vehicle and whether the vehicle is an electric vehicle.

The present disclosure also provides a system and method to control a parking elevator by which a pallet equipped with an electric vehicle charging facility is provided by using information about a vehicle obtained by recognizing a vehicle number and a charging fee is charged and settled together with a parking fee. The present disclosure is to provide an integrated charging and payment management service that includes the above-described services and thus is convenient to an electric vehicle user. The present disclosure provides a system and method by which, when a vehicle enters a place equipped with chargers available for electric vehicles, it is determined whether the vehicle is an electric vehicle and whether there is an available pallet for charging by using, for example, vehicle number recognition technology such as license plate recognition (LPR) and big data technology, to provide the corresponding pallet, and preliminary settlement or automatic payment of the sum of a charging fee and/or a parking fee for the electric vehicle is enabled.

In some embodiments of the present disclosure, a method to control a parking elevator for an electric vehicle based on a vehicle number is provided. The method to control a parking elevator includes: recognizing, by a vehicle number recognition unit, a vehicle number of a vehicle that enters the parking elevator; transmitting, by a local server, the vehicle number to a central server, acquiring, by the central server, vehicle information by accessing a vehicle information database based on the recognized vehicle number and providing the vehicle information to the local server; when the vehicle information includes that the vehicle is an electric vehicle, determining and providing, by the local server, a pallet capable of charging based on the vehicle information; and when there is a request for settlement of a parking fee, generating, by the local server, billing information by calculating the sum of a parking fee and a charging fee.

Preferably, the local server transmits the vehicle number and the billing information to the central server, and the central server performs settlement for an outgoing vehicle based on the vehicle number and the billing information.

The foregoing summary is illustrative only and is not intended to be in any way limiting. In addition to the illustrative embodiments and features described above, further embodiments and features will become apparent by reference to the drawings and the following detailed description.

### BRIEF DESCRIPTION OF THE DRAWINGS

The foregoing and other features of the present disclosure will be described in detail with reference to the accompanying drawings. Understanding that these drawings depict only several examples in accordance with the disclosure and are, therefore, not to be considered limiting of its scope, the disclosure will be described with additional specificity and detail through use of the accompanying drawings, in which:

FIG. 1 is a diagram illustrating an example system for providing available parking pallet information of a parking elevator, in accordance with at least some embodiments of the present disclosure;

FIG. 2 is a diagram illustrating an example system for providing available parking pallet information of a parking elevator comprised of a client and a server, in accordance with at least some embodiments of the present disclosure;

FIG. 3 is a diagram illustrating an example of pallet information provided to a client, in accordance with at least some embodiments of the present disclosure;

FIG. 4 is a diagram illustrating another example system for providing available parking pallet information of a parking elevator comprised of a client and a server, in accordance with at least some embodiments of the present disclosure;

FIG. 5 is a flowchart illustrating an example process for providing available pallet information to a vehicle that enters a parking elevator system, in accordance with a preferred embodiment of the present disclosure;

FIG. 6 is a flowchart illustrating an example process for providing available pallet information of a parking elevator system, in accordance with a preferred embodiment of the present disclosure;

FIG. 7 is a flowchart illustrating an example process for providing available pallet information of a parking elevator system, in accordance with another preferred embodiment of the present disclosure; and

FIG. 8 is a flowchart illustrating an example process for performing, by a local server, settlement and payment of a parking fee and a charging fee in a parking elevator, in accordance with at least some embodiments of the present disclosure.

### DETAILED DESCRIPTION

Hereafter, embodiments and examples will be described in detail with reference to the accompanying drawings so that the present disclosure may be readily implemented by those skilled in the art. However, it is to be noted that the present disclosure is not limited to the embodiments and examples but can be embodied in various other ways.

The present disclosure generally relates to a method, system and program stored in a computer readable storage medium for providing available parking pallet information of a parking elevator based on a vehicle number.

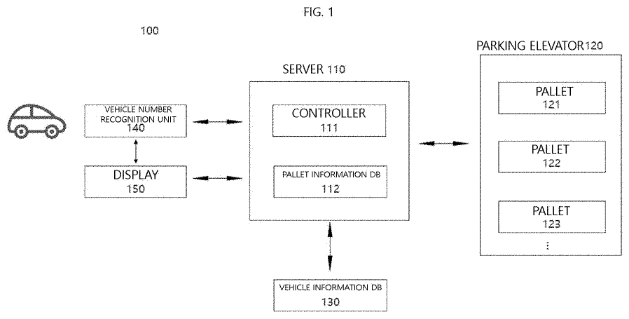

FIG. 1 is a diagram illustrating an example system 100 for searching for vehicle information based on a vehicle number and providing available parking pallet information, in accordance with at least some embodiments of the present disclosure. Example system 100 may include a server 110 and a parking elevator 120. Here, server 110 may be an application server, a standalone server, a web server, or any computing device having data transmission/reception functions, data identification functions and data processing functions. In the present embodiment, server 110 is assumed to be a local server that manages one or more elevators located in one place, but is not limited thereto. Although not illustrated in the drawing, server 110 may be connected to a remote integrated server that communicates to manage a plurality of parking elevators located in a plurality of different places. Although FIG. 1 illustrates that there is only one parking elevator 120, example system 100 may include a parking lot equipped with a plurality of parking elevators 120 shown in FIG. 1 according to an embodiment of the present disclosure. However, in FIG. 1, the relationship between server 110 and one parking elevator 120 is illustrated for convenience of explanation. Parking elevator 120 may include a plurality of pallets 121, 122 and 123. A commercially operated parking elevator can typically have tens to hundreds of pallets. A user (not shown) may be allowed to park a vehicle on a pallet.

The plurality of pallets 121, 122 and 123 may be designed to have different dimensions such as length or height depending on the specifications of vehicles that can be accommodated. As for privately owned vehicles, they may be classified into a light car, a compact car, a medium-sized car and a full-sized car, and vehicles such as SUVs may be classified into a 5-6 passenger vehicle, a 7-8 passenger vehicle and the like. Pallets corresponding to 9 or more passenger vans may also be provided. In order to increase the parking density, the dimensions of a vehicle permitted to be parked may be previously determined for each pallet. If the dimensions are too excessively subdivided, any empty pallet may not serve as a suitable pallet for a vehicle. Therefore, the design of various types of pallets can be appropriately adjusted according to statistics.

Some pallets may be equipped with charging facilities in case of parking of an electric vehicle. A pallet equipped with a charging facility may be linked with a payment system for paying a charging fee. Alternatively, a parking fee may be calculated differently without charging a fee depending on the charge amount.

System 100 may include a vehicle number recognition unit 140 configured to recognize a vehicle number first when a vehicle arrives at a parking elevator. The recognition of a vehicle number may use a conventional technology of license plate recognition (LPR). LPR refers to a device that automatically recognizes and reads a license plate. LPR is based on optical character reader (OCR) technology. That is, a rectangular license plate-shaped object is primarily extracted from digital image information input through an image sensor from a CCD camera and then, text is secondarily extracted from an image in the rectangular object. Here, the process of primarily extracting the shape of the license plate is not very difficult because there are few images of a rectangular license plate shape in the vehicle, and as for a parking lot, it is very easy because the direction of the camera is adjusted to be close to the vehicle when the vehicle enters the parking lot. However, the process of secondarily extracting text and numbers from the license plate is likely to be accompanied by errors because it is influenced by the condition of the license plate, weather, lighting, and the like. Recently, however, LPR solutions that have been commercially available show very high levels of accuracy and the recognition success rates of about 100% in any weather or environment condition. Further, when non-recognition or mis-recognition occurs, a correction process can be performed based on various correction algorithms, but a detailed description thereof is omitted in the present disclosure.

A controller 111 controls the overall operation of system 100. When the vehicle number is recognized by vehicle number recognition unit 140, controller 111 may access a vehicle information database 130 to search for vehicle information corresponding to the vehicle number. Vehicle information database 130 has a data structure of the vehicle information corresponding to the vehicle number. The vehicle information may include a vehicle model, the dimensions of the vehicle and whether the vehicle is an electric vehicle. System 100 may have its own vehicle information database 130, or may access an external database, which provides vehicle information, to acquire necessary information, but is not limited thereto. The same applies to other embodiments of the present disclosure. When vehicle information database 130 is an external database, it may be an external server that provides big data. In this case, information may be provided for a fee.

System 100 may include a pallet information database 112 that stores pallet information for each of pallets 121, 122 and 123. The pallet information may include the specification of a vehicle, i.e., the dimensions of a vehicle, that can be accommodated by a corresponding pallet, and may also include whether a charging facility available for an electric vehicle is provided. Further, pallet information database 112 may store whether each pallet is currently in use. Also, pallet information database 112 may store whether each pallet currently has an error and needs to be checked and repaired. Pallet information database 112 may be provided for each parking elevator, and may be a remote database that collectively manages pallet information of a plurality of parking elevators, but is not limited thereto. The same applies to other embodiments of the present disclosure.

When the vehicle number is recognized by vehicle number recognition unit 140, controller 111 searches vehicle information database 130 for vehicle information corresponding to the vehicle and searches pallet information database 112 for an available parking pallet based on the searched vehicle information. Controller 111 may select a pallet on which the vehicle can be parked from among currently available parking pallets and provide an optimal pallet for increasing the parking density. If there is a currently available parking pallet, controller 111 may display that there is an available parking pallet through a display 150 installed near the vehicle number recognition unit. If the vehicle decides to use the parking elevator or enters the parking elevator, controller 111 may immediately prepare a pallet, which has been determined to be available for parking, to allow the vehicle to be parked. Display 150 may be integrally formed with vehicle number recognition unit 140. If there is a plurality of parking elevators 120, the location or number of a parking elevator equipped with an available parking pallet can be displayed. An indication that there is no available parking pallet may be displayed on display 150.

After the vehicle information is acquired, display 150 may provide an advertisement customized for the vehicle information. After acquiring the vehicle information, server 110 may provide advertisements based on the vehicle information, for example, insurance advertisements and maintenance company advertisements directly necessary for the vehicle. Alternatively, a customized advertisement may be provided based on the age and gender of the driver based on the vehicle information. However, since such information of the driver includes personal information, it is desirable to provide advertisements only to users who have agreed to provide advertisements based on such information by contract. Server 110 may be equipped with an advertisement control unit (not shown) so as to be linked with display 150 in order to provide such customized advertisements, and may be linked with an advertisement providing server (not shown) as necessary. An advertisement may be preferably displayed after a sufficient period of time (for example, 5 seconds) has elapsed after the necessary information is provided to the user, and then it is possible to simultaneously or alternately provide the necessary information and the advertisement.

The customized advertisement may be displayed through a touch screen or a digital signage installed at another location in the parking elevator in addition to display 150. For example, when a vehicle exits, while the vehicle's pallet is moved from the elevator to a discharge position, a digital signage can be installed near the discharge position and a customized advertisement based on information about the vehicle parked on the pallet can be displayed. Alternatively, after an appropriate period of time has elapsed after a user completes fee settlement through a touch screen provided for fee settlement, an advertisement may be provided, or the fee settlement screen may be divided to provide a customized advertisement in one part.

Server 110 may perform various functions for managing the parking elevator, such as a function to charge and settle a fee, in addition to the function to provide pallet information, but a detailed description thereof is not provided in the present disclosure.

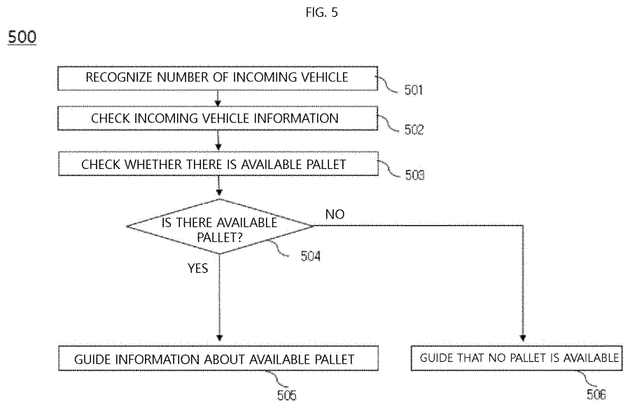

FIG. 5 is a flowchart illustrating an example process for providing available pallet information to a vehicle that enters a parking elevator system, in accordance with at least embodiments of the present disclosure. The flowchart of FIG. 5 is based on an algorithm implemented on system 100 of FIG. 1. Hereinafter, each component of system 100 of FIG. 1 is used to describe each process of FIG. 5, but the processes of FIG. 5 are not necessarily limited thereto. A processing may begin at block 501 where the number of an incoming vehicle is recognized. When the vehicle enters and arrives at vehicle number recognition unit 140, vehicle number recognition unit 140 automatically recognizes a vehicle number using an LPR device or the like. The recognized vehicle number is transmitted to server 110, and the processing may be performed at block 502 where information about the incoming vehicle is checked.

At block 502 where the information about the incoming vehicle is checked, controller 111 provides the received vehicle number to vehicle information database 130 to search for vehicle information corresponding thereto and acquires the searched vehicle information. The vehicle information may include the dimensions of the vehicle required to provide an optimal plate and whether the vehicle is an electric vehicle that needs a charging facility.

Subsequently, controller 111 checks whether a pallet corresponding to the vehicle information remains among currently empty pallets. To this end, controller 111 may provide the acquired vehicle information to pallet information database 112 to obtain a check result. Pallet information database 112 needs to reflect the current operational status of the pallets in real time.

At block 504, guidance information to be provided to the user is determined based on whether there is an available pallet. If there is an available pallet, the processing may continue to block 505 to guide information about the available pallet through display 150. The pallet information may include location information of the parking elevator where the pallet can be used, parking fee information, whether an electric vehicle can be charged, charging fee information, and the like. If there is no available pallet, the processing may continue to block 506 to guide that no pallet is available through display 150.

As described above, according to the present disclosure, even if a staff is not on site for guidance in a parking elevator, vehicle information can be searched by recognizing a vehicle number of a vehicle that is about to use the parking elevator and a user can be immediately informed of whether there is an available parking pallet, and, thus, the convenience in using the parking elevator can be improved. Also, system 100 may increase the parking density by providing a pallet suitable for a vehicle, and, thus, the operation efficiency of the parking elevator can be increased.

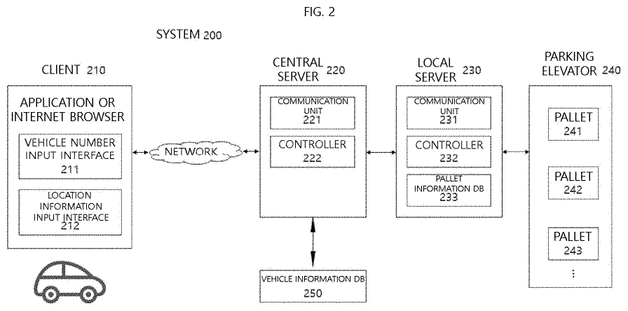

FIG. 2 illustrates an example system 200 in which a vehicle number recognition unit is not used, but a user (not shown) uses a client 210, such as a PC or a mobile device, to transmit a vehicle number to servers 220 and 230 (not shown) and servers 220 and 230 search for vehicle information based on the transmitted vehicle number and provide information about an available parking pallet to client 210, in accordance with another embodiment of the present disclosure. The present embodiment aims to enable the user to check whether there is an available parking pallet before arriving at a parking elevator by driving. It is desirable to provide a service such that the user can check in a mobile device and a desktop environment.

In some examples, client 210 may be a device held by the user, but is not limited thereto. In some examples, client 210 may be any type of computing device such as, a desktop, a laptop, a portable digital assistance (PDA), a smartphone or the like, capable of running a client application.

In some examples, the server may be separated into a central server 220 that communicates directly with client 210 and a local server 230 that manages one or more elevators located in one place, or central server 220 may integrate the function of local server 230, and conversely, local server 230 may perform the function of central server 220, but is not limited thereto. Central server 220 may be a remote server that manages a plurality of parking elevators, but is not limited thereto. The same applies to a server according to other embodiments of the present disclosure. In some examples, servers 220 and 230 may be any type of computing device, such as an application server, a standalone server, a web server, other server devices having data transmission/reception functions, data identification functions and data processing functions, and a large server system, configured to run applications that can be used to manage parking elevators.

Unlike FIG. 1, FIG. 2 illustrates that the vehicle number is not recognized by a vehicle number recognition unit, but transmitted to client 210 by communication with central server 220 through a network. For a vehicle arriving at a parking elevator without checking pallet information in advance, system 200 may provide the above-described embodiment by means of a vehicle number identification unit (not shown).

Client 210 may access central server 220 through the network. Central server 220 may be equipped with a communication unit 221 for communication with a client. Central server 220 may request the user's membership information in order to allow access of client 210. Central server 220 may check whether the user is a member registered in advance, and provide additional services to the member registered in advance. The additional services may include coupons, points and discount vouchers. In general, the process of membership registration may cause inconvenience, and in particular, the user may not have enough time for membership registration when driving. Therefore, an unregistered user may be allowed to access central server 220. Central server 220 is preferably opened to provide a parking space to an unspecified number of vehicles, and it is desirable to provide a service to induce users to perform membership registration by providing additional benefits to members.

Client 210 may be installed with an application which is run such that client 210 can access central server 220 of the parking elevator and receive information about an available parking pallet. Alternatively, client 210 may access central server 220 on a web page using an Internet browser.

Client 210 may first search for the location of a parking elevator. To this end, it is desirable to first transmit, to central server 220, current location information of the client or location information of an area where the user wants to park as a destination location. As for a mobile device, location information of client 210 may be acquired using a GPS. Client 210 may transmit, to central server 220, the GPS location information as a destination location. If the GPS is not used, the current location or destination location may be input manually. In this case, a location input interface 212 may be provided to client 210. Central server 220 may search for an available parking elevator around the current location or the destination location and provide a search result to client 210 so as to be displayed on a map of an application or a web browser or provide the search result in a list including addresses.

In some illustrative embodiments, the user may use the system of the present embodiment in a desktop environment to check in advance whether or not the vehicle can be parked at a destination before getting in the vehicle. In the desktop environment, the user can input a destination location where the user wants to park the vehicle through an interface of an application or a web browser. The user may input an address or a name, such as the name of a subway station or building. If the application or the web browser provides a map, the user may mark the destination location on the map. The user expects the application to provide information about an available parking elevator or pallet around the destination location.

When central server 220 receives the destination location, central server 220 may transmit information about parking elevators around the destination location to client 210. To this end, central server 220 may be equipped with a database (not shown) including information about parking elevators distributed throughout the country and establishing communication with central server 220. The user may select a suitable parking elevator from among the parking elevators around the destination location provided from central server 220.

When a parking elevator to be used is selected, client 210 may provide the user with an interface 211 that enables the user to input the vehicle number. The user may input the vehicle number of the vehicle to be parked. If the user is a member registered in advance at central server 220, the user may select a previously input vehicle number to simplify an input process, or may automatically use a designated vehicle number to skip the input process. The input vehicle number is transmitted to central server 220 through the network.

Central server 220 searches a vehicle information database 250 based on the received vehicle information and acquires vehicle information. Then, central server 220 transmits the vehicle information to local server 230 of the selected parking elevator by communication with local server 230. Local server 230 accesses a pallet information database 233 to select an optimal available parking pallet based on the vehicle information and transmits information about the pallet to central server 220, and the pallet information is transmitted to client 210. In some illustrative embodiments, local server 230 may access client 210 through the network to transmit information about the selected pallet directly to client 210.

The transmitted pallet information may be displayed on the screen of client 210. Whether an available parking pallet is currently ready, location information of an elevator to be accessed to push the vehicle to the available parking pallet and whether an electric vehicle can be parked may be displayed on client 210.

System 200 may provide a function to reserve a pallet. When client 210 recognizes the available parking pallet information, client 210 may transmit, to servers 220 and 230, a reservation request to use the available parking pallet. In order to suppress a decrease in the operation efficiency of system 200 caused by no-show, a valid reservation time may be limited. For example, if a reservation is valid for 10 minutes and the vehicle does not arrive at a parking elevator within 10 minutes, the reservation may be invalidated and the user may be notified in advance. System 200 may charge a fee in advance for reservation.

Central server 220 and local server 230 may be used for settlement of a parking fee. For example, local server 230 may generate billing information by collecting fees to be charged, and central server 220 may be configured to be associated with a payment system to enable the charged fees to be paid and settled. If the provided pallet is equipped with an electric vehicle charging facility, a charging fee may be charged. The charging fee is preferably billed together with the parking fee.

In one example, if a pallet provides a charging facility (not shown), local server 230 may receive, from one or more pallets, charge amount information of a vehicle chargeably connected to each charger. Local server 230 may calculate a charging fee based, at least in part, on the charge amount information. Here, the one or more pallets may include a charger information provider installed in association with each charger. The charger information provider may include a QR code or an NFC tag. One or more user devices may read charger identification information using the charger information provider. The one or more user devices may store information about the pallet where the vehicle is parked or perform preliminary settlement of the fee after parking has been completed based on the charger identification information.

When charging has been completed, a controller 232 may receive, from a charger of a pallet, charge amount information (e.g., charging time, supply capacity, type of charger, charging speed, etc.) of a parking vehicle chargeably connected to the charger of the pallet, and calculate a charging fee based on the charge amount information. When parking on the pallet has been completed, controller 232 may calculate a total fee by calculating the sum of the charge fee and the parking fee. Client 210 may perform settlement of the calculated total fee.

A charger provided in an electric vehicle pallet may include a QR code or an NFC tag that provides charger information, and may also provide charger identification information, such as a charger number and an identification number of the pallet provided with the charger. The client can read the charger identification information using the QR code or NFC tag, and can store the identification number of the pallet on the application based on the recognized charger identification information or perform preliminary settlement of a fee after charging has been completed.

Local server 230 may sum up a charging fee calculated based on, for example, vehicle model, charging time, supply capacity, type of charger and/or charging speed and a parking fee calculated based on vehicle model, date and time of entry, date and time of parking on a charging parking surface, date and time of completion of charging and/or date and time of preliminary settlement request, set the sum of the fees as a fee to be paid at the time of settlement, and provide such information to central server 220.

Central server 220 may perform settlement for an outgoing vehicle based on the vehicle number and a fee of the outgoing vehicle. For example, central server 220 may check whether or not the fee has been preliminarily settled through the user device. In addition, central server 220 may perform automatic payment of the fee based on automatic payment information registered in advance corresponding to the fee and the number of the outgoing vehicle. When the preliminary settlement or automatic payment is confirmed, central server 220 may transmit a notification of completion of settlement to local server 230. For example, local server 230 may check whether or not fee settlement for the outgoing vehicle has been completed based on the notification of completion of settlement from central server 220. Local server 230 may perform payment of the fee at an exitway to perform settlement of the fee of a vehicle for which preliminary settlement or automatic payment has not been performed.

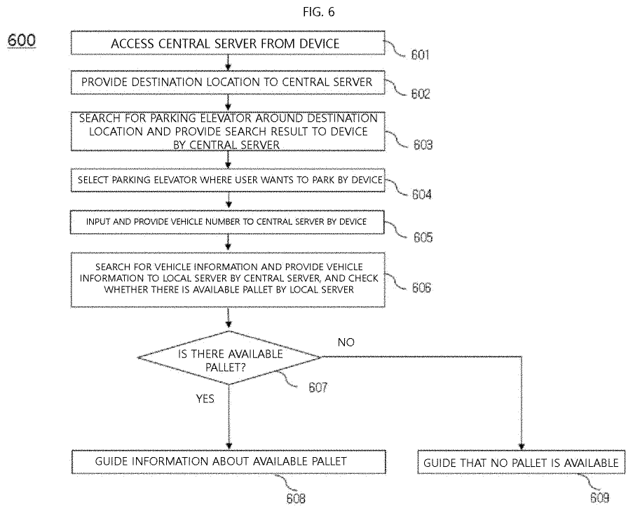

FIG. 6 is a flowchart of using a system of the present embodiment to check in advance whether there is an available parking pallet before the user arrives in a parking elevator at the destination in some illustrative embodiments. The flowchart of FIG. 6 is based on an algorithm implemented on system 200 of FIG. 2, but the process of FIG. 6 is not necessarily limited thereto. The user may first access the central server using an application installed on a mobile device or a web browser on a desktop PC at block 601. At block 602, the user may use a device to provide a destination location to the central server. If the device is a mobile device, the current location identified using a GPS device may be automatically provided. At block 603, the central server may search for a parking elevator located around the destination location and provide a search result to the user's device in the form of a map or a list. The user may select a parking elevator where the user wants to park the vehicle at block 604 and input a vehicle number through the device so as to be provided to the central server at block 605. This series of processes replaces block 501 where the vehicle number of an incoming vehicle is recognized according to an embodiment illustrated in FIG. 5. Subsequent processes 606, 607, 608 and 609 are substantially the same as the processes below block 502 of FIG. 5. However, a guide 608 about available pallet information and a guide 609 about the impossibility of parking may be displayed on the device of client 210 of FIG. 2, instead of display 150 of FIG. 1.

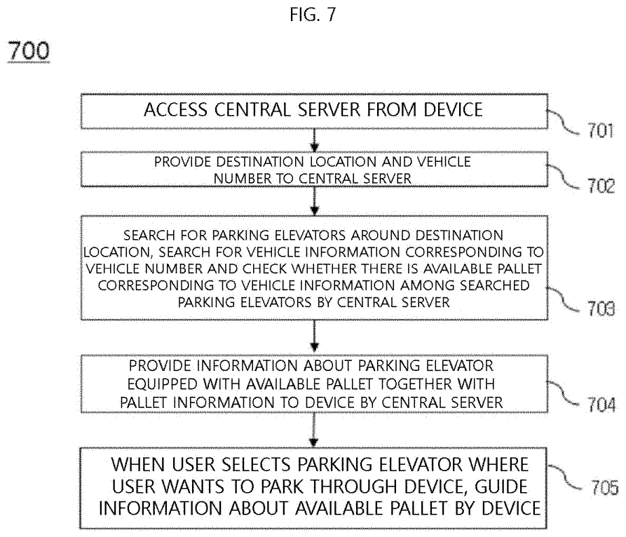

In another embodiment, the user may search for a parking elevator equipped with a currently available pallet by providing a vehicle number in advance before searching for a parking elevator around the destination location. To this end, client 210 may first receive the vehicle number from the user before searching for an available parking elevator. FIG. 7 is a flowchart illustrating the processes of this embodiment. FIG. 7 is based on an algorithm implemented on system 200 of FIG. 2. Hereinafter, each component of system 200 of FIG. 2 is used to describe each process of FIG. 7, but the processes of FIG. 7 are not necessarily limited thereto. At block 701, the user may access the central server through the device. At block 702, a destination location input by the user or recognized by a GPS device and a vehicle number input by the user or previously stored are transmitted to central server 220 through the device. Desirably, the location information and the vehicle number are provided to central server 220 at the same time. At block 703, central server 220 searches for parking elevators around the destination location based on the location information of the destination location, acquires vehicle information based on the received vehicle number, and transmits the vehicle information to local server 230 of the searched parking elevators to check whether there is a currently available pallet. At block 704, central server 220 receives information about currently available parking pallets from local servers 230 and then transmits information about parking elevators equipped with the currently available parking pallets to the device of client 210, and client 210 may display the locations of currently available parking elevators on a map of an application or a web browser, or provide the locations in a list including addresses. At block 705, when the user selects one of a plurality of parking elevators equipped with currently available parking pallets, the user may receive a guide about access information of available pallets of the selected parking elevator. In this embodiment, the possibility for the user of selecting a parking elevator without a currently available pallet is eliminated, and, thus, the convenience of the user can be further improved.

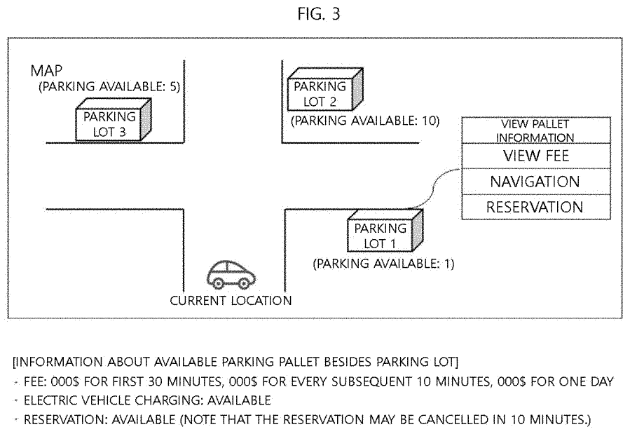

FIG. 3 illustrates a screen provided by an application or a web browser of client 210, which is an embodiment of a screen that provides location information of an available parking elevator and information about an available parking pallet. The location information of the available parking elevator may be displayed on a map, or may be provided in a list including an address, but is not limited thereto. FIG. 3 shows an embodiment of displaying the location information on a map.

Commercially available map data may be used as a map, or a map made by a service provider may be used. Desirably, the client device and the application provide a GPS function to use the map. The current location of a vehicle is displayed on the map and available parking elevators around the vehicle are displayed. In a method for displaying on the map, before the user provides a vehicle number to system 200, it is desirable to display all the parking elevators on the map, and after the vehicle number has already been provided to system 200, it is desirable to display only a parking elevator equipped with an available parking pallet searched based on vehicle information corresponding to the vehicle number, but the present disclosure is not limited thereto. FIG. 3 shows an embodiment of displaying only a parking lot equipped with an available parking pallet on the map after the vehicle number has already been provided. The number of parking available may be displayed together with the location of a parking lot.

For example, if the user selects parking lot 1, available menu items may be displayed. The menu items may include view pallet information, navigation, view fee, reservation and the like, but are not limited thereto. First, a menu item for allowing the user to view available parking pallet information may be provided. When the user selects a menu item to view pallet information, the pallet information may be displayed at the bottom of the map. The displayed pallet information may include fee information, availability of electric vehicle charging, availability of reservation and the like, but is not limited thereto. If the user selects a parking lot displayed on the map before providing the vehicle number, a message “There is no parking pallet available” may be displayed. A menu item to view bill may be prepared separately to check only a fee for an available parking pallet.

The user may call a navigation function by selecting a navigation menu item. A navigation application may be provided by an application of the system or may be linked with another commercially available application. A reservation menu item may be provided to enable the user to reserve a pallet. If there is not enough parking available, it is possible to induce the user to make a reservation.

As described above, according to the present disclosure, the user can check in advance whether there is an available parking pallet before arriving at a parking elevator, and, thus, the convenience in using the parking elevator can be improved.

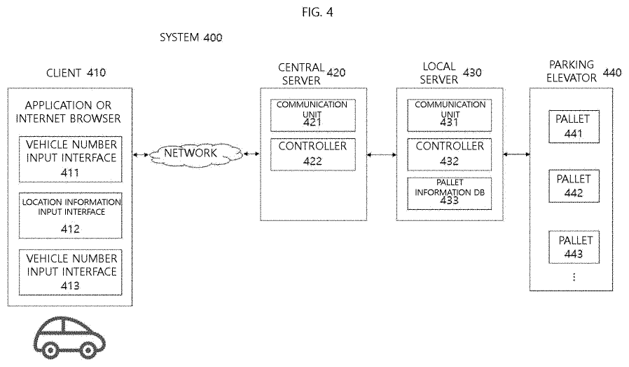

FIG. 4 shows a modification of the embodiment shown in FIG. 2, in accordance with another embodiment of the present disclosure, and illustrates an example system 400 in which a client 410 transmits, instead of the vehicle number, detailed vehicle information (vehicle specification information such as vehicle model, electric vehicle or non-electric vehicle, etc.) or previously stored vehicle information to servers 420 and 430, and servers 420 and 430 provide available parking pallet information to client 410 based on the transmitted vehicle information.

In some examples, client 410 may be a device held by a user, but is not limited thereto as described above. Further, in some examples, the server may be separated into a central server 420 and a local server 430, or they may be configured integrally with each other as described above.

In the embodiment of FIG. 4, central server 420 receives vehicle information directly from client 410 and thus may not need a vehicle information database (not shown) unlike the embodiment of FIG. 2. Therefore, components except vehicle information database 250 of central server 220 of FIG. 2 may be provided in central server 420. The present embodiment aims to enable a user, who is concerned about exposure of personal information by providing a vehicle number, or a user, who has been previously registered at system 400 and input a vehicle number or vehicle information, to more easily check in advance whether there is an available parking pallet before driving to a parking elevator.

Client 410 may access server 420 through a network. Membership information of the user may be required in advance for access. A registered user can input and store vehicle information in advance and can easily provide the vehicle information while searching for a pallet. An unregistered user may input and provide vehicle information. In this case, the provided vehicle information may include the dimensions of a vehicle, whether the vehicle is an electric vehicle, and the like. To this end, a vehicle information input interface 413 may be provided to client 410.

System 400 may provide an interface 411 that enables an unregistered user, who has inconvenience in inputting vehicle information, to input a vehicle number as in the embodiment of FIG. 2, or may provide interface 413 that enables a user, who does not want his/her personal information other than vehicle information to be searched based on his/her vehicle number, to input only necessary vehicle information, or may provide both interfaces 411 and 413.

Client 410 may be installed with an application which is run such that client 410 can access central server 420 and receive information about an available parking pallet. Alternatively, client 210 may access a web browser to access central server 420 on a web page. The process in which client 410 transmits a destination location to central server 420 and central server 420 provides information about parking elevators or available parking elevators around the destination location to client 410 is performed in the same manner as in the embodiment of FIG. 2. However, in the present embodiment, before searching central server 420 for a parking elevator where the user wants to park the vehicle or after selecting a desired parking elevator from among the parking elevators around the destination location provided by central server 420, client 410 may provide the user with interface 413 to ask whether or not to provide vehicle information. The user may input and provide the vehicle information through vehicle information input interface 413, or the registered user may simply provide the vehicle information, which has been input in advance, and thus may skip the input process.

Central server 420 may communicate with local server 430 based on the received location information and vehicle information, and local server 430 may access a pallet information database 433 to select an optimal available parking pallet and transmit information about the pallet to client 410. The transmitted pallet information may be displayed on the screen of client 410 as shown in FIG. 3. That is, whether an available parking pallet is currently ready in each parking elevator, location information of an elevator to be accessed to push the vehicle to the available parking pallet and whether an electric vehicle can be parked may be displayed on client 410. As in the embodiment of FIG. 2, various menu items, such as view pallet information, view fee, navigation, reservation and the like, may be provided.

In another embodiment, if client 410 is provided with vehicle information, the same service may be provided without providing the vehicle information to central server 420. That is, client 410 may transmit only location information of the destination location including the current location to central server 420 to central server 420, and central server 420 may access local server 430 of parking elevator 440 around the received destination location and provide information about all the currently available pallets to client 410. Client 410 already knows the vehicle information and thus filters information about pallets matched with the vehicle information among the currently available parking pallet information to display the locations of parking elevators equipped with the available parking pallets on the map or provide the locations in a list including addresses. In this embodiment, the user can use system 400 without concern about exposure of personal information.

As described above, according to the present disclosure, the user can check in advance whether there is an available parking pallet before arriving at a parking elevator, and, thus, the convenience in using the parking elevator can be improved. Further, it is possible to simply provide vehicle information to a server, and the server does not need to construct, use or access a vehicle information database.

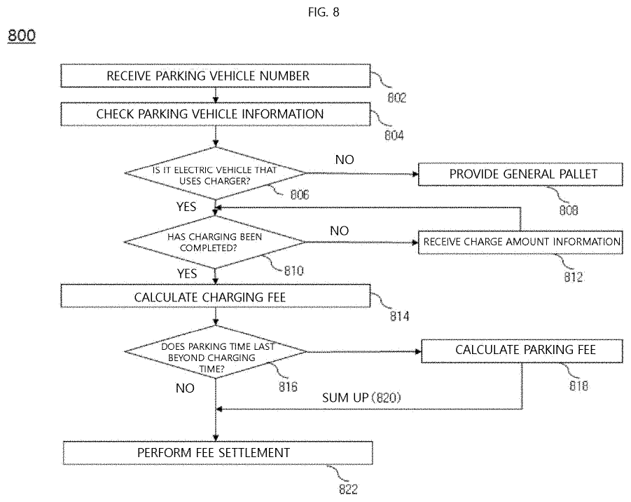

FIG. 8 is a flowchart illustrating an example process for performing, by a local server, settlement and payment of a parking fee and a charging fee in a parking elevator, in accordance with at least some embodiments of the present disclosure. A processing may begin at block 802 where a vehicle number is received. When the vehicle number is recognized at block 802, the processing may continue to block 804 where the vehicle information is checked. Here, the vehicle information is stored and managed in a database of a local server and may include vehicle specification information, such as whether a vehicle is an electric vehicle and vehicle model corresponding to the vehicle number.

Then, the processing may continue from block 804 to block 806 where it is determine whether the vehicle is an electric vehicle. The local server may check whether the parking vehicle is an electric vehicle chargeable by the charger provided on a pallet based on the vehicle number. If it is determined at block 806 that the parking vehicle is not an electric vehicle chargeable by the charger, the processing may continue to block 808 where a general pallet without a charging facility is provided.

If it is determined at block 806 that the parking vehicle is an electric vehicle chargeable by the charger, the processing may continue to block 810 where it is checked whether or not charging has been completed. When charging has not been completed, i.e., while the parking vehicle is charged by the charger, the local server may receive charge amount information of the parking vehicle chargeably connected to the charger. When charging has been completed at block 810, the processing may continue to block 814 where a charging fee is calculated. The local server may calculate a charging fee based on the charge amount information received from each charger during charging. For example, the charge amount information may include electric power supplied, charging time, and the like. In addition, the local server may calculate a charging fee differently depending on the vehicle model based on the parking vehicle information.

Then, the processing may continue from block 714 to block 716 where it is checked whether or not the vehicle is parked beyond the charging time. If the parking vehicle is parked on the pallet while the parking vehicle is not charged by the charger, the local server may determine that the parking vehicle is parked beyond the charging time. For example, if the parking vehicle does not exit from the pallet within a predetermined period of time after charging of the parking vehicle has been completed, the local server may determine that the parking vehicle is parked beyond the charging time. If it is determined that the parking vehicle is parked beyond the charging time, the processing may continue from block 816 to block 818 where a parking fee is calculated. For example, the parking fee may be calculated based on vehicle model confirmed based on the parking vehicle information, parking time before and after charging, time of entry and/or time of exit. The local server may sum up 820 the calculated parking fee and charging fee.

If it is determined at block 816 that no parking time lasts beyond the charging time, the processing may continue to block 822 where the charging fee is settled as a fee to be paid. If it is determined at block 716 that parking time lasts beyond the charging time, the processing may continue from block 818 to block 822 where the sum 820 of the calculated parking fee and charging fee is settled as a fee to be paid. The fee settlement in the local server may include preliminary settlement, automatic payment at an exitway or settlement at the exitway. A user device may request preliminary settlement of the fee based on charger identification information read from a charger information provider (e.g., NFC tag, QR code, etc.) installed in association with each charger, and the local server may perform preliminary settlement of the fee by using automatic payment information in response to the preliminary settlement request from the user device.

The above description of the present disclosure is provided for the purpose of illustration, and it would be understood by a person with ordinary skill in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The claimed subject matter is not limited in scope to the particular implementations described herein. For example, some implementations may be in hardware, such as employed to operate on a device or combination of devices, for example, whereas other implementations may be in software and/or firmware. Likewise, although claimed subject matter is not limited in scope in this respect, some implementations may include one or more articles, such as a signal bearing medium, a storage medium and/or storage media. This storage media, such as CD-ROMs, computer disks, flash memory, or the like, for example, may have instructions stored thereon, that, when executed by a computing device, such as a computing system, computing platform, or other system, for example, may result in execution of a processor in accordance with the claimed subject matter, such as one of the implementations previously described, for example. As one possibility, a computing device may include one or more processing units or processors, one or more input/output devices, such as a display, a keyboard and/or a mouse, and one or more memories, such as static random access memory, dynamic random access memory, flash memory, and/or a hard drive.

There is little distinction left between hardware and software implementations of aspects of systems; the use of hardware or software is generally a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative example of the subject matter described herein applies regardless of the particular type of signal bearing medium used to actually carry out the distribution.

While certain example techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

Throughout this document, the term “connected to” may be used to designate a connection or coupling of one element to another element and includes both an element being “directly connected to” another element and an element being “electronically connected to” another element via another element. Through the whole document, the term “on” that is used to designate a position of one element with respect to another element includes both a case that the one element is adjacent to the other element and a case that any other element exists between these two elements. Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise. Through the whole document, the term “about or approximately” or “substantially” is intended to have meanings close to numerical values or ranges specified with an allowable error and intended to prevent accurate or absolute numerical values disclosed for understanding of the present disclosure from being illegally or unfairly used by any unconscionable third party.

The scope of the present disclosure is defined by the following claims rather than by the detailed description of the embodiment. It shall be understood that all modifications and embodiments conceived from the meaning and scope of the claims and their equivalents are included in the scope of the present disclosure.

1. A method to provide pallet information of a parking elevator based on a vehicle number, comprising:
recognizing, by a vehicle number recognition unit, a vehicle number of a vehicle that enters the parking elevator;
acquiring, by a server, vehicle information by accessing a vehicle information database based on the recognized vehicle number;
determining, by the server, a pallet based on the vehicle information; and
providing pallet information of the determined pallet to a driver of the vehicle.

2. A method to provide pallet information of a parking elevator system that is performed by a central server or a local server, comprising:
allowing access to the system in response to a request from a user's device;
receiving information about a vehicle through the device; and
providing pallet information corresponding to the information about the vehicle to the device.

3. A method to provide pallet information of a plurality of parking elevator systems that is performed by a central server configured to communicate with a user's device and a plurality of local servers, comprising:
allowing access requested through the device;
receiving information about a destination location and a vehicle through the device;
transmitting the information about the destination location and the vehicle to the plurality of local servers;
receiving available parking pallet information corresponding to the information about the vehicle from the plurality of local servers; and
providing parking elevator information including the available parking pallet information to the device.

4. The method to provide pallet information of claim 1, wherein the information about the vehicle includes the dimensions of the vehicle.

5. The method to provide pallet information of claim 2, further comprising:
when the information about the vehicle is a vehicle number, acquiring, by the central server or local server that has received a vehicle number, additional information about the vehicle by accessing a vehicle information database based on the vehicle number,
wherein the additional information includes at least one of the dimensions of the vehicle and whether the vehicle is an electric vehicle.

6. The method to provide pallet information of claim 1, wherein the information about the vehicle includes whether the vehicle is an electric vehicle, and the pallet information includes whether an electric vehicle charging facility is provided.

7. The method to provide pallet information of claim 1, wherein the pallet information includes a plurality of pallet information from one or more parking elevators, and
each pallet information indicates the location of a parking elevator corresponding to each pallet.

8. A parking elevator system equipped with a plurality of pallets, comprising:
a parking number recognition unit that recognizes a vehicle number;
a vehicle information database that stores vehicle information corresponding to the vehicle number;
a pallet information database that stores pallet information for each pallet, including the dimensions of a vehicle permitted to be parked on the pallet and whether a charging facility is provided; and
a controller that receives the recognized vehicle number, acquires vehicle information corresponding to the recognized vehicle number from the vehicle information database, and searches for pallet information corresponding to the vehicle information.

9. A server that provides pallet information of a parking elevator system, comprising:
a communication unit that communicates with a user's device and a local server of the parking elevator system; and
a controller that receives information about a vehicle from the device through the communication unit and provides pallet information corresponding to the vehicle information to the device.

10. The server that provides pallet information of claim 9,
wherein when the information about the vehicle is a vehicle number, the server that has received the vehicle number accesses a vehicle information database based on the vehicle number to acquire additional information about the vehicle, and
the additional information includes at least one of the dimensions of the vehicle and whether the vehicle is an electric vehicle.

11. A method to control a parking elevator for an electric vehicle based on a vehicle number, comprising:
recognizing, by a vehicle number recognition unit, a vehicle number of a vehicle that enters the parking elevator;
transmitting, by a local server, the vehicle number to a central server, acquiring, by the central server, vehicle information by accessing a vehicle information database based on the recognized vehicle number and providing the vehicle information to the local server;
when the vehicle information includes that the vehicle is an electric vehicle, determining and providing, by the local server, a pallet capable of charging based on the vehicle information; and
when there is a request for settlement of a parking fee, generating, by the local server, billing information by calculating the sum of a parking fee and a charging fee.

12. The method to control a parking elevator of claim 11,
wherein the local server transmits the vehicle number and the billing information to the central server, and
the central server performs settlement for an outgoing vehicle based on the vehicle number and the billing information.
